(19) United States
(12) Patent Application Publication
(10) Pub. No.: US 2017/0091347 A1
(43) Pub. Date: Mar. 30, 2017

(54) METHOD FOR MODELING A TECHNICAL SYSTEM

(71) Applicants: Markus Michael Geipel, München (DE); Steffen Lamparter, Feldkirchen (DE); Martin Ringsquandl, Traunstein (DE)

(72) Inventors: Markus Michael Geipel, München (DE); Steffen Lamparter, Feldkirchen (DE); Martin Ringsquandl, Traunstein (DE)

(21) Appl. No.: 15/278,293

(22) Filed: Sep. 28, 2016

(30) Foreign Application Priority Data
Sep. 29, 2015 (DE) 102015218744.6

(51) Int. Cl. G06F 17/50; G06N 99/00

(52) U.S. Cl. CPC G06F 17/50; G06N 99/005

(57) ABSTRACT

In the method for modeling a technical system, a semantic system model of the technical system is generated and the dependencies inside the system model are analyzed by a dependency analysis based on properties of the semantic system model.

This application claims the benefit of DE 10 2015 218 744.6, filed on Sep. 29, 2015, which is hereby incorporated by reference in its entirety.

### TECHNICAL FIELD

The embodiments relate to a method for modeling a technical system.

### BACKGROUND

The modeling of technical systems is becoming increasingly important, in particular for the operation and optimization of such complex technical systems. For example, so-called learning models are used to optimize gas turbines and for predictive maintenance and to reduce costs when operating machines.

A great challenge when analyzing data from complex technical systems is the high-dimensional data space of the data connections of the technical system. For example, a modern large gas turbine provides data for more than 10,000 variables. In the bodywork section of a vehicle production line, 150 control devices, for example, provide more than 100,000 variables with a data rate of in total more than 6,000,000 data points per minute. Without any further information, all potential relationships between these variables are taken into account. If two machines each having 100 sensors are considered as a further example, there are 4950 possible relationships between these sensors if these two machines are connected.

Even for the possible sub-combinations with a large set of input variables, the result is combinationally a dramatically increasing number as the number of input variables continues to increase.

Against this background of the prior art, the object of the embodiments disclosed herein is to provide an improved method for modeling a technical system.

### SUMMARY AND DESCRIPTION

The scope of the present invention is defined solely by the appended claims and is not affected to any degree by the statements within this summary The present embodiments may obviate one or more of the drawbacks or limitations in the related art.

In the method for modeling a technical system, a semantic system model of the technical system is first of all generated and the dependencies inside the system model are then analyzed by a dependency analysis based on properties of the semantic system model. That is to say, the properties of the semantic system model are used for the dependency analysis. The relevance of the numerous dependencies may be estimated using the dependency analysis.

In one act of the method, a system model is generated for the technical system. Background knowledge of the technical system is used for this purpose in an automated manner. The technologies that may be used for this purpose are known per se. In one development of the method, the semantic system model is generated using control and/or process and/or composition information.

Such control and/or process and/or composition information is expediently available as a sensor name system, for instance, and/or as a power plant identifier system (KKS), in particular. Further information sources are, for instance, automation systems, e.g., the TIA model (TIA=“Totally integrated systems”) from Siemens. It is also possible to use information from layout plans and/or installation plans of the technical system. In addition, it is possible to use control routines that control the control devices of the technical system.

Each model entity is expediently represented in a knowledge representation language. Established knowledge representation languages may be used for this purpose, in particular OWL (OWL=“Web Ontology Language”) and/or RDF (RDF=“Resource Description Framework”). In this case, information from different information sources as described above is suitably combined in a single ontology. Terms of the ontology that correspond to one another may be semantically identified and equated with one another, that is to say the ontology is accordingly consolidated. This establishes a context between the individual model entities and the data flow taking place between them.

The semantic system model obtained may then be compressed. For this purpose, the system model is reduced to the relevant relationships between model entities. This is carried out using a dependency analysis. For this purpose, potential dependencies between entities or components of the system model are first of all determined. Such relevant relationships result, in particular, from the same physical environment (e.g., specifically spatial vicinity and/or particularly small deviations of the ambient temperatures) and/or from process relationships between entities and/or control by the same system part or the same software and/or common resources, specifically a common energy supply, and/or common operation by operating personnel and/or other common features, (e.g., an identical manufacturer, the same operating age and/or the same configuration).

These relevant dependencies may be formalized, in particular may be expressed as a “part of” relationship of entities, as a temporal “afterward” relationship between production acts or as a control logic relationship in the form of a “calculated on the basis of” relationship or as an entity with particular parts, resources or properties as a “has” relationship.

The resulting semantic system model is now independent of the information sources that were originally used to model the system. Furthermore, the semantic system model is independent of the respective specific technical field of the technical system (for instance energy generation or manufacturing, etc.) and, at the same time, remains formalized in a knowledge representation language.

In one development of the method, the dependencies are weighted in the system model on the basis of the dependency analysis.

In the method, the dependencies may be weighted in the system model by reducing the number of dependencies on the basis of the dependency analysis.

It is not necessary to manually reduce the high-dimensional data space of a complex technical system. The effort required for this purpose, the comprehensive substantive clarification and agreement with relevantly knowledgeable engineers for different parts or processes of the system are unnecessary. Consequently, the system may also be modeled considerably more quickly. In particular, the method is also not subject to any intellectual bias that gives rise to the risk, in particular, of important relationships between parts or entities of the system being erroneously disregarded or not being appropriately considered.

The method may be scaled in a considerably better manner with regard to high-dimensional data spaces since the number of possible dependencies may be considerably reduced. In particular, it is possible to handle technical systems that were previously deprived of in-depth system modeling on account of their great complexity.

The quality of analytical models is considerably improved, with the result that better predictions, cause clarifications and control of the system are possible in an improved manner.

In one advantageous development of the method, the dependency analysis checks whether a respective dependency is a directed dependency.

Dependency relationships and independence relationships between individual system entities are suitably determined as explained below.

In the present case, independence refers to a directed and direct relationship. Directed refers to an example where variable A depends on B, but B is not necessarily dependent on A (for example, rain is independent of the wetness of a road, but the wetness of the road is entirely dependent on the occurrence of rain). Direct refers to an example where two variables already do not have a dependency relationship to one another, merely because a first of the two variables directly depends on a third variable that directly depends on a second of the two variables. These two variables are only indirectly dependent on one another.

The dependency relationships are now derived from the relevant dependencies of the system model.

If it is true for two variables, for instance, that the first of the two variables is part of a first component of the system and the second of the two variables is part of a second component of the system and also that the two components of the system are physically isolated from one another, it is concluded: the two variables are each independent of one another.

If a variable also occurs in a subsequent process act in the sense of an “afterward” relationship in comparison with a second variable, this second variable is independent of the variable that occurs subsequently.

If a second variable has also been calculated on the basis of the first variable, the first variable is independent of the second variable, but the second variable is dependent on the first variable.

Furthermore, the relationship “not independent” is respectively set between A and B, for instance for a “has” relationship, according to which a component of the system has the entities A and B.

In this manner, the semantic system model may be abstracted to the corresponding dependency information.

This accordingly abstracted semantic system model may be subjected to a context-sensitive analysis. Three methods are available for this purpose. To begin, cause information is obtained from the dependency analysis. Causality may be reliably inferred, in particular, from a close temporal sequence of events of a technical process. Furthermore, the control instructions of the control devices may be used for this purpose.

This relationship may be illustrated as follows. It is known, for instance, that the variable B is independent of the variable A. It is also known that the variables A and B have a high correlation to one another. Both items of information, considered together, allow the conclusion that A depends on B. If there were a plurality of variables, a simultaneously existing dependency of A and B on a third variable would also need to be checked in the sense of a common cause. Appropriate algorithms for this are known per se.

The dependency information may then be used to carry out a system analysis that otherwise may not have been carried out on account of a high-dimensional data space.

For the sake of illustration, the method is designed in such a manner that, for instance, a relationship to a class variable C in a technical process, for instance for the purpose of predicting failure, may be classified as relevant and irrelevant with respect to C on the basis of the dependency and causality relationships. All direct dependencies of the class variable C on other variables are expediently retained as relevant. In contrast, all influencing variables on which C is only indirectly dependent are not retained as a relevant relationship. Accordingly, the dependencies of the class variable C are considerably reduced. Furthermore, those variables that occur later than the class variable C cannot be considered any further since causes temporally precede their effects.

The method described above may be used in a method for cause clarification. For this purpose, the relevant dependencies are evaluated according to a possible cause, for instance for a fault that occurs in the technical system. The information from the semantic system model is also used for this purpose, in particular.

In the method, results of the dependency analysis may be used and the technical system is monitored and/or the system is controlled and/or such control is improved and/or a cause analysis for processes of the technical system is carried out and/or data relating to the technical system are analyzed on the basis of said results.

The method may be designed to be self-learning.

The computer program product is designed to carry out one of the preceding methods.

### BRIEF DESCRIPTION OF THE DRAWINGS

FIG. 1 schematically depicts an example of the process acts of a method for modeling a technical system.

FIG. 2 schematically depicts an example of the dependency analysis in a process act of the method according to FIG. 1.

### DETAILED DESCRIPTION

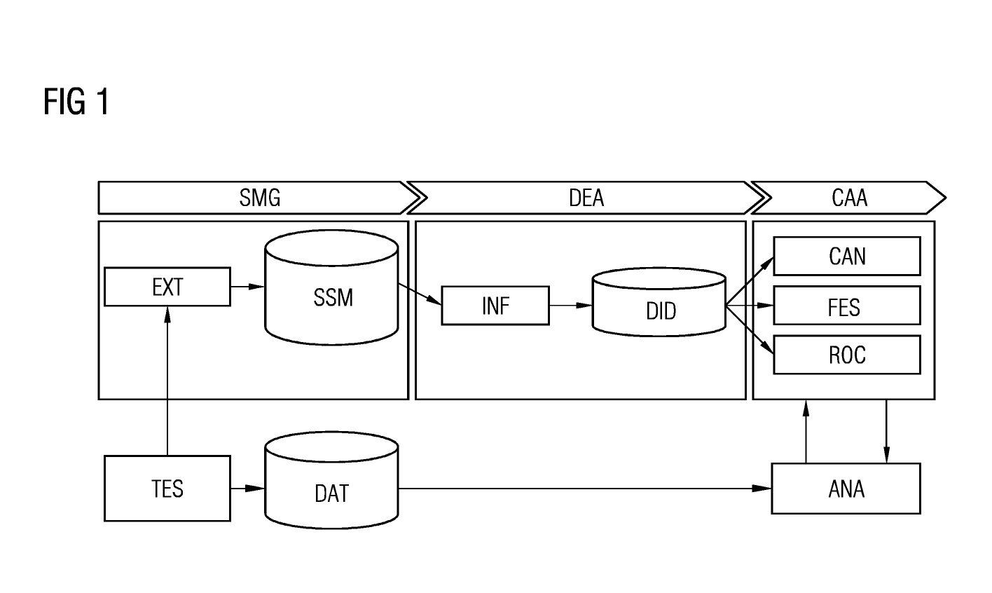

The system analysis method illustrated in FIG. 1 is part of a method for predicting quality problems when welding on doors in a vehicle production line of a factory hall manufacturing system. This factory hall manufacturing system forms the technical system TES. In further exemplary embodiments not specifically illustrated, the method is part of another downstream data analysis.

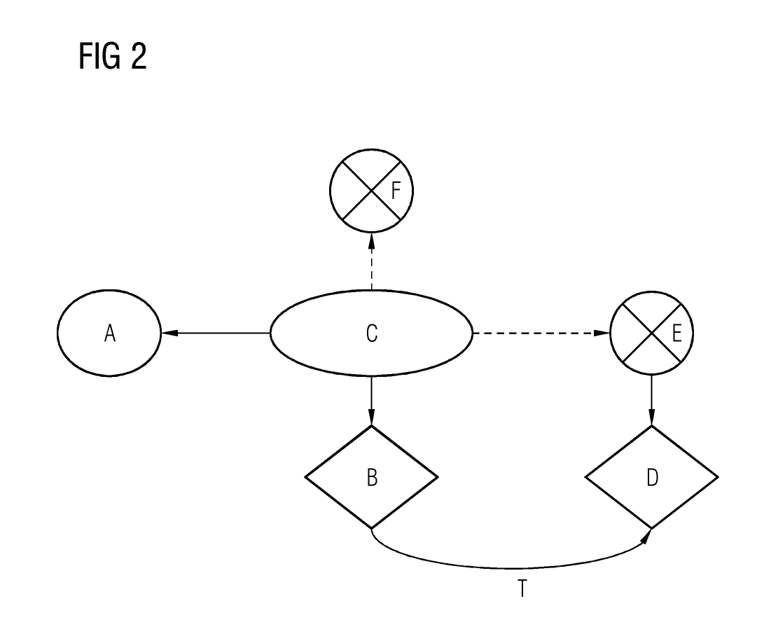

In the case of the technical system TES, the task arises of predicting quality problems with doors on the basis of preceding events and measurements. The last control device in the assembly line is responsible for checking the quality and triggers a door quality event C (also see FIG. 2) if a gap dimension between the door and the rest of the vehicle differs from a predefined desired range. The causes of such events may either be incorrectly set assembly robots or else problems when positioning the rest of the vehicle or incorrect acceptance of the door by assembly robots or a series of other causes. For the specific data analysis ANA, the data DAT first of all need to be obtained as described below:

A semantic system model SSM is first of all generated SMG. The layout plans for setting up PLC units (PLC=“Programmable Logic Controller”) are used for this purpose and the semantic information EXT that may be obtained therefrom is recorded in a standard semantic system model SSM. It is also possible to use manufacturing process models available, for example, in the Simatic IT MES manufacturing software package.

This is now followed by a dependency analysis DEA: relationships INF of variables with physical sensors and relationships of these sensors with the PLC units are derived from the semantic system model SSM. A number of local relationships and “is part of” relationships are consequently therefore set up in an automated manner. The programs that control the PLC units, (e.g., written in the IEC-61331-3 programming language), reveal relationships in the form of computational dependencies. Furthermore, a set of temporal relationships, that is to say relationships of the type “precedes” and “follows”, may be derived using the manufacturing models.

In the dependency analysis DEA, PLC units F physically separate from one another and variables measured after the door assembly act B in terms of time, and are therefore provided with the temporal “follows” relationship S, are now (see FIG. 2) marked as being independent of the door quality event C. Those variables significant after the door assembly act in terms of time include, for example, those E during the assembly D of the inner door lining. A reasoning software component, a so-called “Semantic Reasoner”, is used for this purpose in a manner known per se. As described above, this software component maps temporal relationships of variables to dependency relationships. Direct dependencies D are derived using the production process information that relates the door quality event and a positioning event to one another using a particular reason (for instance processing of the same component), for instance. The dependency analysis now reduces the derived relationships INF to only direct dependencies DID.

This is followed, as part of the data analysis ANA, by a context-sensitive analysis CAA in which door quality events are predicted by a nearest neighbor classification of those variables that directly influence the door quality, that is to say the door quality events are directly dependent on these variables. A nearest neighbor classification may be carried out using algorithms that are known per se. The result is a considerably reduced model of direct dependencies. For instance, the assembly of the inner door lining is no longer considered for the problem of the door assembly quality. Accordingly, the result is a considerably reduced problem space in which further classifications, combinations or predictions may be made.

In contrast, if an adequate dependency analysis cannot be carried out using the preceding acts, a simple dependency graph, which contains only “depends on” relationships, is derived from the semantic model. Such a linear dependency model is configured to the conditions of the semantic model using a learning algorithm.

In principle, a cause clarification ROC or else another extraction of substantially appearing properties FES may also be made as part of the context-sensitive analysis in further exemplary embodiments.

A second exemplary embodiment relates to the cause clarification of an abnormal fuel temperature in a gas turbine. For this purpose, a semantic model of the sensor system is first of all formed using a power plant identifier system (KKS). The structure of the system applies a number of dependency-relevant relationships to the system: the direction of the mass flow through the system is clear and is stipulated in advance. The mass flow through the system results in a number of temporal “afterward” relationships of the individual entities. For example, the temperature and the composition of a fuel unit are measured before it is ignited. Furthermore, in contrast, the exhaust gas temperature is measured later. The structure of the system also includes numerous “is part of” relationships.

The dependency analysis is carried out in a similar manner to the preceding exemplary embodiment. On account of the temporal “afterward” relationships, it follows, for instance, that the fuel temperature is independent of the exhaust gas temperature, while the reverse does not necessarily apply. A cause clarification is carried out on the basis of this dependency analysis. The ultimate cause of an abnormal fuel temperature is determined on the basis of the cause clarification. The exhaust gas temperature is automatically excluded from the set of possible causes on the basis of the dependency analysis.

The above-described method may be implemented via a computer program product including one or more readable storage media having stored thereon instructions executable by one or more processors of the computing system. Execution of the instructions causes the computing system to perform operations corresponding with the acts of the method described above.

The instructions for implementing processes or methods described herein may be provided on computer-readable storage media or memories, such as a cache, buffer, RAM, FLASH, removable media, hard drive, or other computer readable storage media. A processor performs or executes the instructions to train and/or apply a trained model for controlling a system. Computer readable storage media include various types of volatile and non-volatile storage media. The functions, acts, or tasks illustrated in the figures or described herein may be executed in response to one or more sets of instructions stored in or on computer readable storage media. The functions, acts or tasks may be independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for modeling a technical system, the method comprising:
generating a semantic system model of the technical system; and
analyzing dependencies inside the semantic system model by a dependency analysis based on properties of the semantic system model.

2. The method of claim 1, wherein the semantic system model is generated using control information, process information, composition information, or any combination thereof.

3. The method of claim 2, wherein the dependencies are weighted in the system model based on the dependency analysis.

4. The method of claim 3, wherein the dependencies are weighted in the semantic system model by reducing a number of dependencies based on the dependency analysis.

5. The method of claim 4, wherein the dependency analysis checks whether a respective dependency is a directed dependency.

6. The method of claim 1, wherein the dependencies are weighted in the system model based on the dependency analysis.

7. The method of claim 1, wherein the dependencies are weighted in the semantic system model by reducing a number of dependencies based on the dependency analysis.

8. The method of claim 1, wherein the dependency analysis checks whether a respective dependency is a directed dependency.

9. The method of claim 1, further comprising:
monitoring the technical system, controlling the technical system, improving control of the technical system, or a combination thereof, based on results of the dependency analysis.

10. The method of claim 9, further comprising:
analyzing data relating to the technical system based on the results of the dependency analysis.

11. The method of claim 10, further comprising:
carrying out a cause analysis for processes of the technical system based on the results of the dependency analysis.

12. The method of claim 9, further comprising:
carrying out a cause analysis for processes of the technical system based on the results of the dependency analysis.

13. The method of claim 1, further comprising:
analyzing data relating to the technical system based on results of the dependency analysis.

14. The method of claim 13, further comprising:
carrying out a cause analysis for processes of the technical system based on results of the dependency analysis.

15. The method of claim 1, further comprising:
carrying out a cause analysis for processes of the technical system based on results of the dependency analysis.

16. The method of claim 1, wherein the semantic system model is self-learning.

17. A computer program product comprising:
a computer program code for one or more programs,
wherein the computer program code is configured to, with at least one processor, cause an apparatus to at least perform:
generate a semantic system model of the technical system; and
analyze dependencies inside the semantic system model by a dependency analysis based on properties of the semantic system model.

18. The computer program product of claim 17, wherein the computer program code is configured to, with at least one processor, cause an apparatus to at least further perform:
monitor the technical system, control the technical system, improve control of the technical system, or a combination thereof, based on results of the dependency analysis.

19. The computer program product of claim 17, wherein the computer program code is configured to, with at least one processor, cause an apparatus to at least further perform:
analyze data relating to the technical system based on results of the dependency analysis.

20. The computer program product of claim 17, wherein the computer program code is configured to, with at least one processor, cause an apparatus to at least further perform:
carry out a cause analysis for processes of the technical system based on results of the dependency analysis.
